(19) United States
(12) Patent Application Publication
(10) Pub. No.: US 2014/0032265 A1
(43) Pub. Date: Jan. 30, 2014

(54) SYSTEMS AND METHODS OF AGGREGATING CONSUMER INFORMATION

(71) Applicant: Experian Marketing Solutions, Inc., Schaumburg, IL (US)

(72) Inventor: Scott Paprocki, Austin, TX (US)

(73) Assignee: Experian Marketing Solutions, Inc., Schaumburg, IL (US)

(21) Appl. No.: 13/951,941

(22) Filed: Jul. 26, 2013

Related U.S. Application Data
(60) Provisional application No. 61/676,185, filed on Jul. 26, 2012.

(51) Int. Cl. G06Q 30/02

(52) U.S. Cl. CPC G06Q 30/0201
USPC 705/7.29

(57) ABSTRACT

Disclosed herein are systems and methods of aggregating consumer data. The data may be acquired from numerous sources so that small portions of reliable data may be gathered into a single data set. Furthermore, by aggregating and analyzing such data, new insights and information about consumers may be discovered. Additionally disclosed are computer implemented arrangements for sharing of information that may provide incentives for data to be shared for purposes of aggregation and analysis. Some embodiments include a cooperative database system in which entities, such as marketers or communicators, may exchange data relating to consumers, such as email list activity data.

### CROSS-REFERENCE TO RELATED APPLICATIONS

This application claims the benefit of priority under 35 U.S.C. §119(e) of U.S. Provisional Application No. 61/676,185, filed Jul. 26, 2012, the disclosure of which is hereby incorporated by reference in its entirety.

### BACKGROUND

Computer technology enables vast amounts of consumer information to be generated on a constant basis. Such consumer information is valuable to companies seeking to market products and services to those consumers. However, a key problem for such marketers is the reliability of consumer information. While accurate information can lead to effective targeted marketing, inaccurate information can lead to wasted marketing resources and even potential embarrassing situations for marketers.

Many companies maintain small portions of highly reliable consumer information. For example, a company operating a mailing list may have information about the activity of mailing list subscribers. Such information may be highly accurate but nevertheless limited in value since it relates to activities of only consumers on the company's mailing list.

### SUMMARY

Disclosed herein are systems and methods of aggregating consumer data. The data may be acquired from numerous sources so that small portions of reliable data may be gathered into a single data set. Furthermore, by aggregating and analyzing such data, new insights and information about consumers may be discovered. Additionally disclosed are computer implemented arrangements for sharing of information that may provide incentives for data to be shared for purposes of aggregation and analysis.

Some embodiments include a cooperative database system in which entities, such as marketers or communicators, may exchange data relating to consumers, such as email list activity data. The marketers may provide raw data that may be used to generate useful insights about consumers, and then may receive those insights, as well as other data, through an exchange arrangement. Many of the insights are valuable to marketers. For example, the system may identify locations of consumers and the best times of day and days of the week to reach consumers, which can help the marketers send messages that are more likely to be read. Additionally, the system may identify the type of devices used by consumers to read messages, provide demographic and segmentation information about consumers, correlate consumers with previous activities such as purchases, determine levels of consumer activity, and so on. The system may also provide reports and metrics to inform marketers on the success of their marketing campaigns, including behavioral analysis data, levels of activity, comparisons with other marketers, and so on. These metrics and insights may allow marketers and other entities to improve multi-channel marketing campaigns, send appropriately targeted messages to consumers, make informed decisions about consumers, and develop strategies to reengage inactive consumers, among other things.

### BRIEF DESCRIPTION OF THE DRAWINGS

FIG. 1 is a block diagram of a computing system for data exchange as used in an embodiment.

FIG. 2 is a block diagram of a computing system as used in an embodiment.

FIG. 3 is a flowchart of a process of aggregating and sharing consumer information, as used in an embodiment.

FIG. 4 is a flowchart of a process of sharing consumer data as used in an embodiment.

FIG. 5 is a block diagram of a data exchange record that may be sent from a communicator to a data exchange system as used in an embodiment.

FIG. 6 is a block diagram of a data record stored by an exchange system and relating to a communicator, as used in an embodiment.

FIG. 7 is a block diagram of a data record stored by the exchange system and related to a consumer, as used in an embodiment.

FIG. 8 is a flowchart of a process of gathering and analyzing consumer data, as used in an embodiment.

FIG. 9 is a flowchart of a process of providing data to a communicator, as used in an embodiment.

FIG. 10 is a block diagram of an implementation of a data exchange system and a flowchart of a process of managing consumer information, as used in an embodiment.

FIG. 11 shows a data table and corresponding graphs illustrating an example of email action insight data which may be generated by a data exchange system according to the processes described herein, as used in an embodiment.

FIG. 12 shows a data table and corresponding graphs illustrating an example of email activity score insight data which may be generated by a data exchange system according to the processes described herein, as used in an embodiment.

FIG. 13 shows a data table and corresponding graphs illustrating an example of email type insight data which may be generated by a data exchange system according to the processes described herein, as used in an embodiment.

FIG. 14 shows a data table and corresponding graph illustrating an example of recency of engagement insight data which may be generated by a data exchange system according to the processes described herein, as used in an embodiment.

FIG. 15 shows a data table and corresponding graphs illustrating an example of best time to email insight data which may be generated by a data exchange system according to the processes described herein, as used in an embodiment.

### DETAILED DESCRIPTION

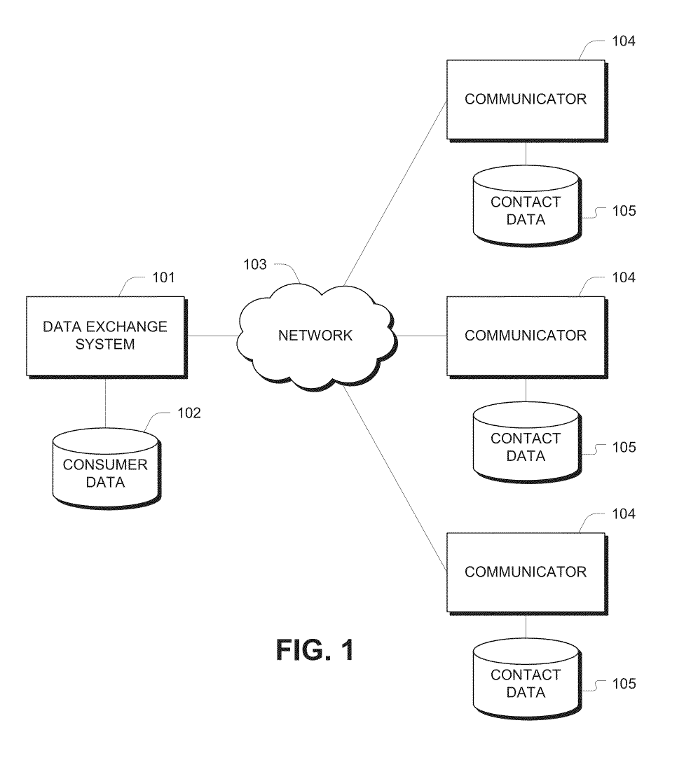

FIG. 1 is a block diagram of a computing system for data exchange as used in an embodiment. In various embodiments, additional blocks may be included, some blocks may be removed, and/or blocks may be connected or arranged differently from what is shown.

Data exchange system 101 may include one or more computing devices with computer software and/or hardware such as processors, memory, and computer readable storage. In various embodiments, data exchange system 101 may receive consumer information, analyze and/or aggregate that information, and share the results of that analysis and/or aggregation, optionally along with the originally received data, with third parties.

Data exchange system 101 may be connected to one or more sources of consumer data 102. The consumer data may include identifiers of consumers such as personal information, contact information, location information, demographic information, behavioral information, and the like. The consumer data may be stored internally within data exchange system 101 and/or retrieved from an external data source connected by a network and/or other communication system.

Data exchange system 101 may further be connected to one or more networks 103 such as the internet, a LAN, a WAN, a virtual private network, and/or any combination of these networks or other networks. Through network 103, data exchange system may communicate with one or more communicators 104. Communicators 104 may be computing systems and/or other entities that provide information to and/or receive information from data exchange system 101. In various embodiments, communicators 104 may be marketers, businesses, organizations, groups, communities, and/or the like, as well as computing systems operated by such entities. Throughout this specification the term “communicator” may be used to refer to either a computing system or an entity operating the computing system, as appropriate.

Communicators may maintain lists of contacts such as email lists, phone number lists, SMS text message contact lists, physical mailing address lists, social media lists such as friends lists, account username lists, web cookie lists, and the like. Communicators may send out communications, such as promotional materials, via these contact lists. Additionally, communicators 104 may monitor activities performed by consumers receiving those communications. Contact lists and/or activity monitoring data may be stored by communicators 104 in contact data store 105. All or part of the data stored in contact data store 105 may then be transmitted to data exchange system 101 via network 103. The data may be transferred in real time as contact data store 105 is updated, and/or it may be sent to data exchange system on a periodic basis such as an hourly, daily, or weekly basis. Additionally, data shared by data exchange system 101 may be transferred via network 103 to communicators 104 so that those communicators may store the shared data in contact data store 105 and/or otherwise use the shared data. In an embodiment, the data exchange system 101 may receive consumer data from the communicators 104. In other embodiments, the data exchange system 101 may receive the consumer data from a third party tracking service which collects and stores activity monitoring data on behalf of the communicators 104.

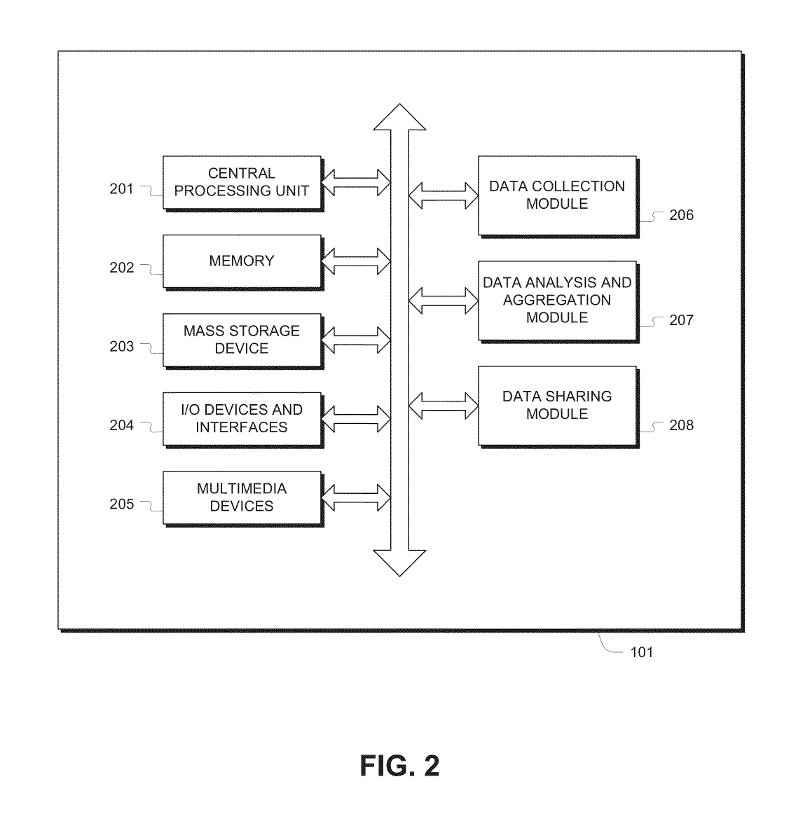

FIG. 2 is a block diagram of a computing system as used in an embodiment. In various embodiments, additional blocks may be included, some blocks may be removed, and/or blocks may be connected or arranged differently from what is shown.

The computing system of FIG. 2 may be, for example, data exchange system 101 and/or another computing system. Data exchange system 101 may be one or more computing devices, including computer hardware. Data exchange system 101 may further include one or more modules which may be implemented as executable instructions in software and/or hardware such as circuitry. Data exchange system 101 may further include data storage systems such as hard disks, read only memory, random access memory, flash memory, removable storage media, and the like.

The data exchange system 101 may be a general purpose computer using one or more microprocessors, such as, for example, an Intel® Pentium® processor, an Intel® Pentium® II processor, an Intel® Pentium® Pro processor, an Intel® Pentium® IV processor, an Intel® Pentium® D processor, an Intel® Core™ processor, an xx86 processor, an 8051 processor, a MIPS processor, a Power PC processor, a SPARC processor, an Alpha processor, and so forth. The computer may run a variety of operating systems that perform standard operating system functions such as, for example, opening, reading, writing, and closing a file. It is recognized that other operating systems may be used, such as, for example, Microsoft® Windows® 3.X, Microsoft® Windows 98, Microsoft® Windows® 2000, Microsoft® Windows® NT, Microsoft® Windows® CE, Microsoft® Windows® ME, Microsoft® Windows® XP, Windows® 7, Palm Pilot OS, Apple® MacOS®, Disk Operating System (DOS), UNIX, IRIX, Solaris, SunOS, FreeBSD, Linux®, or IBM® OS/2® operating systems. In other embodiments, the promotion management system 101 may be controlled by a proprietary operating system. Conventional operating systems control and schedule computer processes for execution, perform memory management, provide file system, networking, I/O services, and provide a user interface, such as a graphical user interface (“GUI”), among other things.

The data exchange system 101 may include one or more central processing units (“CPU”) 201, which may each include one or more conventional or proprietary microprocessor(s). The data exchange system 101 may further include one or more memories 202, such as random access memory (“RAM”), for temporary storage of information, read only memory (“ROM”) for permanent storage of information, and/or a mass storage device 203, such as a hard drive, diskette, or optical media storage device. The memory 202 may store software code, or instructions, for execution by the processor 201 in order to cause the computing device to perform certain operations, such as gathering sensor-related data, processing the data with statistical and/or predictive models, formatting data for user devices or other presentation, transmitting data, or other operations described or used herein.

The methods described and claimed herein may be performed by any suitable computing device, such as the data exchange system 101. The methods may be executed on such suitable computing devices in response to execution of software instructions or other executable code read from a tangible computer readable medium or computer storage device. A computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

The data exchange system 101 may include one or more input/output (I/O) devices and interfaces 204, such as a keyboard, trackball, mouse, drawing tablet, joystick, game controller, touchscreen (e.g., capacitive or resistive touchscreen), touchpad, accelerometer, and/or printer, for example. The data exchange system 101 may also include one or more multimedia devices 205, such as a display device (also referred to herein as a display screen), which may also be one of the I/O devices 204 in the case of a touchscreen, for example. Display devices may include LCD, OLED, or other thin screen display surfaces, a monitor, television, projector, or any other device that visually depicts user interfaces and data to viewers. The data exchange system 101 may also include one or more multimedia devices, such as speakers, video cards, graphics accelerators, and microphones, for example.

In one embodiment, the I/O devices and interfaces 204 provide a communication interface to various external devices via a network such as network 103 of FIG. 1. For example, the data exchange system 101 may be electronically coupled to the network 103 via a wired, wireless, or combination of wired and wireless, communication link(s). The network 103 may allow communication with various other computing devices and/or other electronic devices via wired or wireless communication links.

Data exchange system 101 may also include one or more modules which may be implemented as hardware or software including executable instructions. In an embodiment, data exchange system 101 includes data collection module 206, data analysis and aggregation module 207, and data sharing module 208. In various embodiments, additional modules may be included and/or any subset of these modules may be included. In various embodiments, one or more of data collection module 206, data analysis and aggregation module 207, and/or data sharing module 208 may be housed on separate computing devices connected via a network or other communications system. In an embodiment, each of the modules is housed on a separate computing device thereby enabling different security settings to be implemented for each of the modules. The modules perform various processes and operations as described throughout the specification.

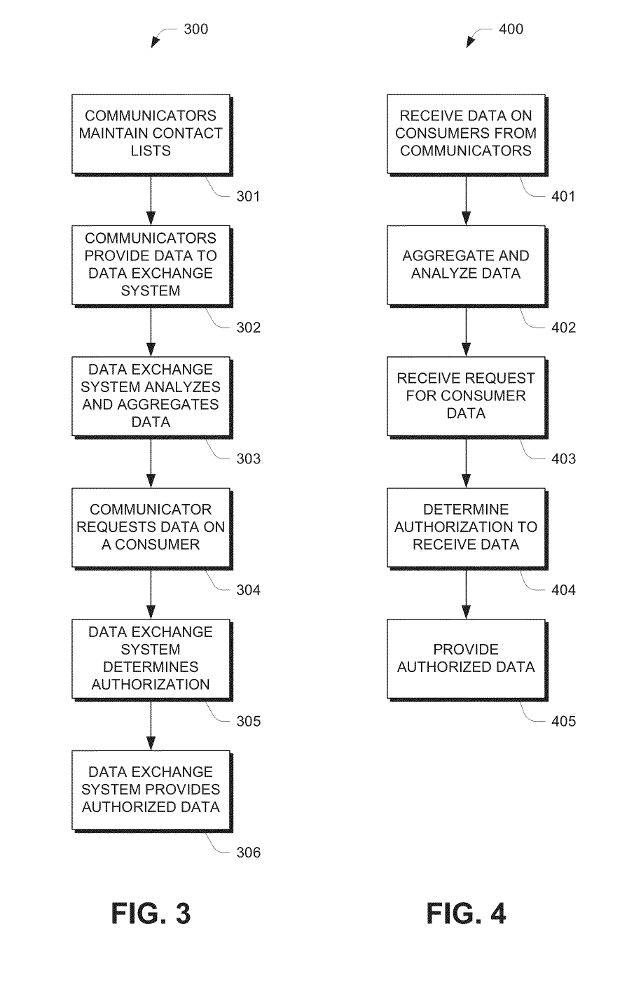

FIG. 3 is a flowchart of a process 300 of aggregating and sharing consumer information, as used in an embodiment. In various embodiments, additional blocks may be included, some blocks may be removed, and/or blocks may be connected or arranged differently from what is shown.

At block 301, one or more communicators maintain contact lists relating to consumers. The contact lists may be email lists, phone number lists, SMS text message lists, physical mailing lists, social media, contact lists, any type of contact lists described herein, and the like. Communicators may further maintain data relating to activity of consumers with respect to those lists. Such activity may include, for example, reading a communication sent by a communicator to consumers, forwarding such communications, sharing the communication on a social network, and so on. Other types of actions, although not specifically discussed herein, may also be maintained.

At block 302, the communicators may provide data from block 301 to the data exchange system. The data may be provided via a network protocol such as HTTP, FTP, SFTP, SCP, WebDAV, and the like. The data may be stored, for example, at the consumer data store 102 and accessed as part of the process 300.

At block 303, the data exchange system analyses and aggregates the data received at block 302. The aggregation may occur on a periodic basis and the results of the analysis and aggregation may be stored for later use. Additionally or alternatively, the analysis and aggregation may be performed on a real-time basis upon a request being received by the data exchange system. In such an embodiment, the results may or may not be stored.

At block 304, a communicator may request data relating to one or more consumers. In an embodiment, the communicator transmits the request via a network protocol such as those previously identified. The request may identify the consumer using an identifier such as an email address. The consumer may additionally or alternately be identified by other personal information and/or identifiers associated with the consumer. In an embodiment, the communicator requests data on all consumers associated with that communicator's contact lists. The identity of consumers associated with the communicator's contact lists may be known to the data exchange system, for example, through data received at block 301. Thus, in such an embodiment, the identity of the consumers need not be provided to the data exchange system at block 304.

At block 305, the data exchange system determines the authorization of the communicator initiating the request at block 304, to receive the requested data. If authorization is granted, then at block 306, the data exchange system provides some or all of the authorized data to the communicator.

FIG. 4 is a flowchart of a process 400 of sharing consumer data as used in an embodiment. The process may be performed, for example, by data exchange system 101 of FIG. 1. In various embodiments, additional blocks may be included, some blocks may be removed, and/or blocks may be connected or arranged differently from what is shown.

At block 401, the data exchange system may receive data relating to one or more consumers. The data may be received from one or more communicators. At block 402, the data exchange system aggregates and analyzes the data received at block 401, possibly in combination with additional data available to the data exchange system.

At block 403, the data exchange system receives a request for consumer data from a communicator (e.g., one of the communicators that has provided some of the consumer data at block 401 or a communicator that has not provided any consumer data). The request may be a request as described, for example, with respect to block 304 of FIG. 3. The data exchange system may then determine the communicator's authorization to receive data at block 404. Based on the determined authorization, the data exchange system may then provide authorized data to the communicator at block 405.

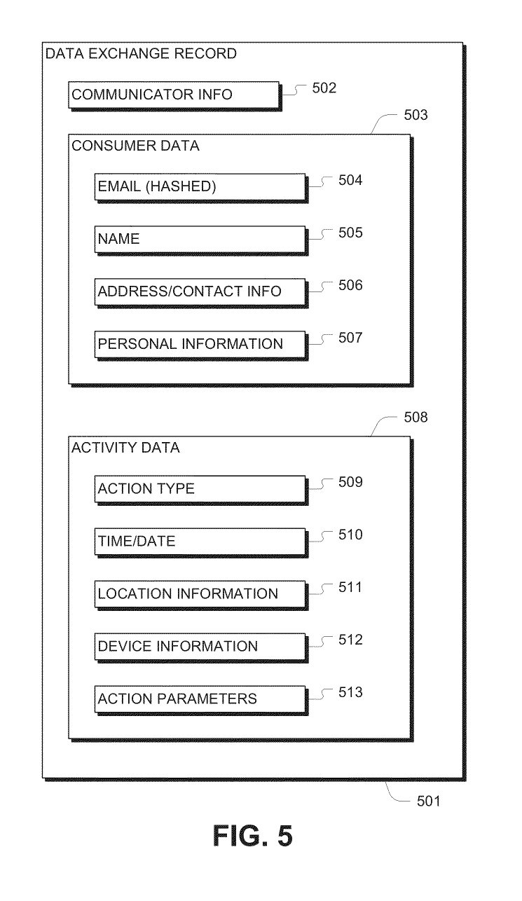

FIG. 5 is a block diagram of a data exchange record 501 that may be sent from a communicator to a data exchange system as used in an embodiment. The data structure may be stored on computer-readable media such as a hard drive, SSD, tape backup, distributed storage, cloud storage, and so on, and may be structured as relational database tables, flat files, C structures, programming language objects, database objects, and the like. In various embodiments, additional elements may be included, some elements may be removed, and/or elements may be arranged differently from what is shown. The data exchange record 501 may be stored, for example, in the consumer data store 102 shown in FIG. 1

Data exchange record 501 may be sent from a communicator to data exchange system 101. The data exchange record may be implemented in a variety of formats such as XML, HTML, CSV, Microsoft Excel, and the like. In various embodiments, multiple data exchange records may be combined and sent to the exchange system simultaneously. In various embodiments, portions of the data exchange record may be sent at different times to the data exchange system, and the data exchange record may be organized, formatted, and rearranged as appropriate for the form of communication between the communicator and the data exchange system.

Data exchange record 501 may include communicator information 502 identifying the communicator sending the data exchange record. In various embodiments, the communicator information 502 may include a name, an identification number, a digital signature, a public and/or private key, and the like. In an embodiment, the communicator information may be included as a header with multiple data exchange records and/or separate from the data exchange records. The communicator information may be used by the data exchange system to identify the sender of the data exchange record so that the data may be stored and processed appropriately.

Data exchange record 501 may include consumer data 503. The consumer data may identify one or more consumers with whom the data exchange record is associated. The consumer data 503 may include an email address 504 or other communication identifier. In an embodiment, email address 504 may be anonymized by being hashed, encrypted, check summed and/or otherwise obfuscated by communicators and/or the data exchange system to protect the identity of the consumer. In another embodiment, the email address is sent in its original form and possibly anonymized by the data exchange system subsequently. Where the email address 504 is anonymized, it may first be converted to a canonical form such as all lowercase to ensure that anonymized email addresses can be later matched with each other. In some embodiments, the email address or other identifier is not anonymized by the communicator or the data exchange system. In an embodiment, the system may include security technologies such as encryption, firewalls, electronic tripwires, access control protections, and the like, to protect the security and privacy of stored data.

Consumer data 503 may also include information such as a name 505, address and/or contact information 506 and/or personal information 507. Specific data fields included in consumer data 503 may include a first name, last name, address, city, state, and/or postal code. Additionally, consumer data 503 may include an identifier of a source from which the consumer record originated. In an embodiment, the source may be “retail,” “store,” and/or “online.” Thus, for example, where a consumer signed up for a mailing list via a website, the source may be “online.” The source may be used, for example, to determine the reliability of the consumer data 503, to determine the consumer's shopping habits or other behavior, to identify preferred marketing techniques, and so on.

Data exchange record 501 may further include activity data 508. The activity data may identify one or more actions or other activities performed by the consumer. Such activity data may be useful, for example, in determining the behavior of the consumer, the interest of the consumer in particular emails, the degree to which the consumer engages with particular messages, and so on.

Activity data 508 may include action type 509 indicating a particular action taken by the consumer. In an embodiment, the action type may be one or more of: sign up for mailing list, open an email, click on links within email, engage in transaction based on email (conversion), unsubscribe from mailing list, share message on social network, and/or forward message. In various embodiments, any subset of these actions may be included and/or additional actions may be included. While the aforementioned actions generally relate to consumers' activity on email mailing lists, other appropriate actions may be defined for other types of contacts and/or communications. In an embodiment, certain actions may not be included in data exchange records 501, such as email addresses determined to be undeliverable by communicators.

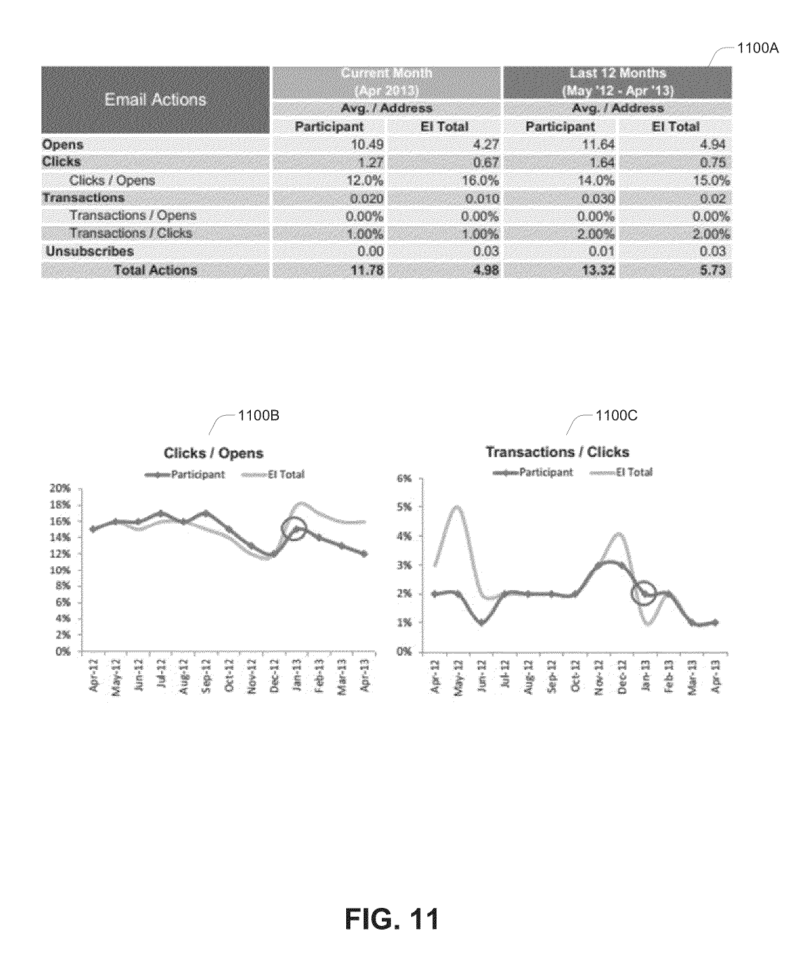

The aforementioned activity types lend to numerous possible insights about consumer behavior. For example, the click, conversion, share, and forward activities indicate a degree of consumer interest in communications, and may be used to assess the consumer's overall interest in communications, interest in communications from a particular communicator, interest in communications having certain content, and so on. In various embodiments, statistical models may be constructed using a degree of consumer interest as a dependent variable and information about communications sent as independent variables, thereby enabling communicators to assess how to best engage consumers. Other data available to the data exchange system or other entities may be used as independent or dependent variables in different models. Such models may be constructed and/or applied by the data exchange system, communicators, and/or third parties. Certain particular models and insights are described throughout this specification. FIGS. 11-15 illustrated and described herein include several examples of different types of insights which may be generated by the data exchange system.

Activity data 508 may additionally include information about a particular action or activity, such as time and/or date stamp 510, location information 511, and/or device information 512. In an embodiment, location information 511 may include a network location, such as an IP address, and/or a physical or geographic location. Device information 512 may identify a particular device used by the consumer in relation to the action identified by action type 509. For example, device information 512 may identify that the consumer was using a mobile phone, tablet device, desktop computer, web mail system, or the like, in connection with the action or activity. Communicators may identify the device used by a consumer to read a message by analyzing certain headers, such as a User-Agent header, and/or other information made by the consumer while receiving, viewing, and/or otherwise interacting with the message. In an embodiment, the communicators determine the device and send an identifier of the device to the data exchange system. In an alternate embodiment, the communicators send the headers and/or other information to the data exchange system, and the data exchange system determines the device.

Activity data 508 may additionally include action parameters 513 that provide additional information relating to the activity or action. The action parameters may be specific to the particular action. For example, where the action is a click, the action parameters may identify the particular link being clicked. Where the action is a conversion, the action parameters may identify the product or service purchased. Where the action is a social share, the action parameters may identify the social network and/or location where the message was shared. Where the action type is a forward, then the action parameters may include the identity of the person to whom the consumer forwarded the message.

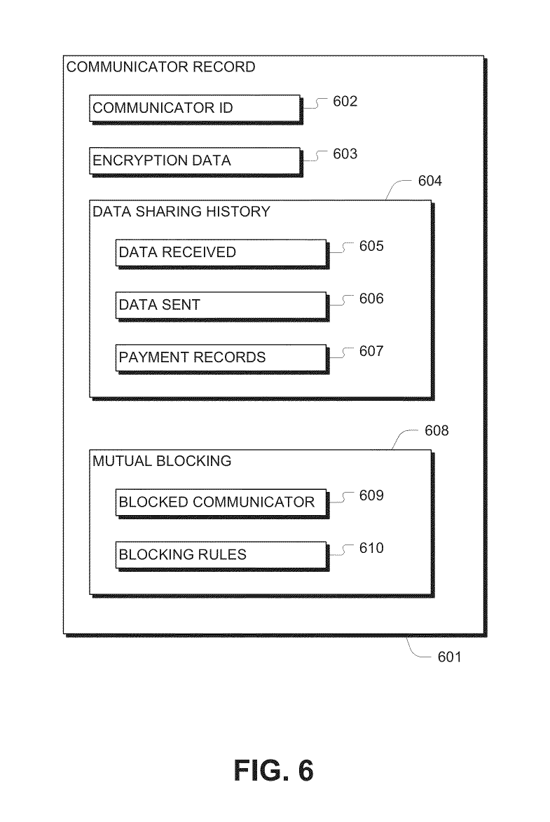

FIG. 6 is a block diagram of a communicator data record 601 stored by an exchange system and relating to a communicator, as used in an embodiment. The data structure may be stored on computer-readable media such as a hard drive, SSD, tape backup, distributed storage, cloud storage, and so on, and may be structured as relational database tables, flat files, C structures, programming language objects, database objects, and the like. In various embodiments, additional elements may be included, some elements may be removed, and/or elements may be arranged differently from what is shown. The communicator data record 601 may be stored, for example, in the consumer data store 102 shown in FIG. 1.

Communicator record 601 may include a communicator identifier 602. The communicator identifier may be used to match against communicator information 502 of FIG. 5. Additional information about communicators, such as names, contact information, account information, login information, authentication information and the like may be stored in communicator record 601. Additionally, communicator record 601 may include encryption data 603, such as public and/or private keys used to encrypt and/or decrypt data sent between the data exchange system and the communicator.

Communicator record 601 may also include data sharing history 604. The data sharing history may identify data sent by the communicator to the data exchange system and/or data shared from the data exchange system to the communicator. Such data may be useful, for example, in determining whether a communicator is permitted to receive consumer data that is requested by the particular communicator. For example, data sharing history 604 may be used to implement a quota requirement in which a communicator is required to provide a search and quantity of data in order to be eligible to receive consumer data from the data exchange system. A quota may be implemented, in various embodiments, as ratio requirement, in which a certain quantity of data shared entitles the communicator to receive a certain quantity of data, where the quantity may be measured in number of records, size of records, number of bytes of data, number of consumers, and the like.

Data sharing history 604 may include records of data received 605, records of data sent 606, and/or payment records 607. The records of data received and sent may include aggregate statistics, such as numbers of records received and sent, and/or detailed logs of particular information received and/or sent. Such data may be useful, for example, in determining whether a communicator has satisfied a quota requirement for receiving data and whether or not the communicator has consumed available quote credits by receiving shared data. Payment record 607 may be used in an embodiment where a communicator may acquire consumer information through payment in addition to or alternatively to meeting a quota requirement. The payment records may include records of payments received and/or records of data shared as a result of payment.

Communicator record 601 may also include mutual blocking information 608. Mutual blocking may enable a particular communicator to prevent another communicator from benefiting from data provided by the initial communicator. For example, if two companies are competitors, then those two companies may wish to prevent each other from benefiting from competitor data. In various embodiments, blocking may be unidirectional or bidirectional. Thus, where a communicator A implements blocking against communicator B, the data exchange system may automatically impose blocking from B to A, or blocking from B to A may be implemented only upon further request from B.

Mutual blocking data 608 may include an identifier of the blocked communicator 609. The identifier may correspond to a communicator identifier 602 of another communicator record. Additionally, mutual blocking data 608 may include one or more blocking rules 610. Such blocking rules may enable blocking on a fine-grained or detailed level. For example, where a communicator wishes for some, but not all, consumer data to be blocked, blocking rule 610 may be installed appropriately.

In an embodiment, the data exchange system may associate communicators with one or more categorizations. The categorizations may identify certain subject matter associated with the communicator, such as news, gaming, social networking, retail, clothing, and the like. In an embodiment, multiple categories may be associated with a particular communicator. The categories associated with a communicator may be stored, for example, in communicator record 601.

In an embodiment, communicators may maintain multiple accounts with the data exchange system. For example, where a communicator operates multiple mailing lists and/or brands, that communicator may maintain multiple accounts for each of the brands. In an embodiment, multiple accounts associated with a communicator may be linked in order to simplify data entry and/or billing arrangements.

In an embodiment, communicators are able to create, disabled, and/or delete accounts on the data exchange system. The data exchange system may further provide options for deleting all associated data when an account is deleted.

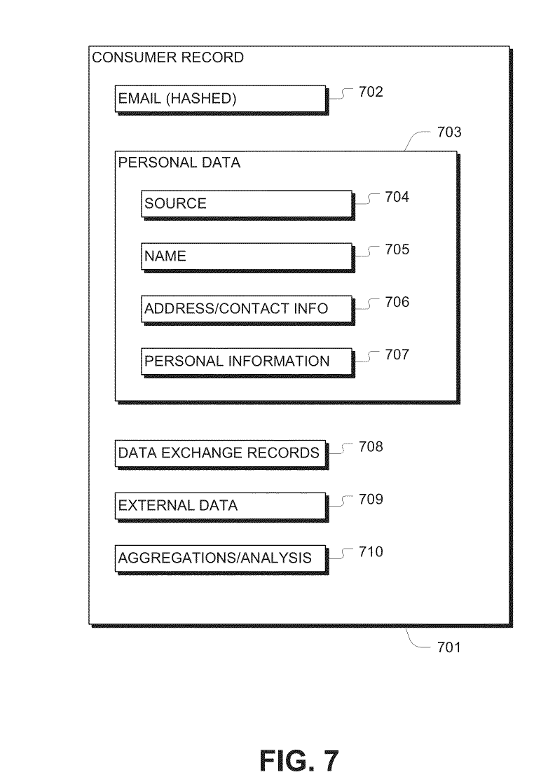

FIG. 7 is a block diagram of a data record stored by the exchange system and related to a consumer, as used in an embodiment. The data structure may be stored on computer-readable media such as a hard drive, SSD, tape backup, distributed storage, cloud storage, and so on, and may be structured as relational database tables, flat files, C structures, programming language objects, database objects, and the like. In various embodiments, additional elements may be included, some elements may be removed, and/or elements may be arranged differently from what is shown.

Consumer record 701 may include an email address 702 or other communication identifier. In an embodiment, the email address 702 may be anonymized by being hashed, encrypted, check summed and/or otherwise obfuscated by communicators and/or the data exchange system to protect the identity of the consumer. In an embodiment, the email address is used as a primary key or unique identifier by which a consumer may be identified. In an embodiment, an email address may be a non-unique identifier, such as in a situation where multiple consumers use a single email address. In various embodiments, identifiers other than email addresses may be used, such as telephone numbers, Social Security numbers, tax identification numbers, names, addresses, and/or the like. In some embodiments, the data exchange system may receive one or more input records (such as a data exchange record 501) and create a unique identifier and/or output record for a consumer (such as a consumer record 701) that aggregates and/or matches the consumer data across communicators/participants. In one embodiment, for example, unique identifiers for a particular consumer may be derived from various information regarding the consumer. For example, an email address of a consumer in a data exchange record from a first communicator may be linked to the consumer identifier and a phone number of the consumer in a data exchange record from a second communicator may also be linked to the consumer identifier. In this way, data exchange records with different data regarding a consumer (e.g., different contact and/or identification data) may be linked together by the common consumer identifier.

Consumer record 701 may also include personal data 703. The personal data may include information identifying a consumer. This data may be used, for example, to ensure the correctness of data received by the data exchange system from communicators. For example, if the data exchange system receives a record with an email address that matches a particular consumer known to the data exchange system, but the address identified by the communicator does not match an address in the consumer record, then the data exchange system may de-prioritize, disregard, or otherwise appropriately treat the record received from the communicator.

Personal data 703 may include a source 704 identifying the origin of the personal data record. The source may be, for example, public records, census data, third party service data, or the like. Additionally, the source may be one or more communicators known to the data exchange system.

Personal data 703 may additionally include name 705 and/or address/contact information 706. Other personal information 707 may also be included, such as telephone numbers, user names, social media accounts, web pages, web cookies, and the like.

In an embodiment, consumer record 701 may include multiple personal data records 703. This may occur, for example, where multiple addresses and/or other information are associated with a particular consumer. By maintaining multiple personal data records, the data exchange system may be able to validate data exchange records having outdated information. Consumer record 701 may further include multiple email addresses, thus accounting for situations where a single consumer uses multiple email accounts. In an embodiment, email addresses or other contact information associated with a consumer are designated as primary, secondary, or tertiary contact information, or given other appropriate designations, to indicate the consumer's predicted to detected use of each form of communication.

Consumer record 701 may additionally be associated with one or more data exchange records 708, such as data exchange record 501 of FIG. 5. The associated data exchange records may be matched to consumer record 701 based on the email address 702 and email address 504 of FIG. 5. Consumer record 701 may further be associated with external data 709 which may be drawn from internal and/or external data sources, such as a consumer data store 102 of FIG. 1. External date 709 may include segmentation data, household income data, family data, reverse spend data, customer modeling data, demographic data, behavioral data, and so on. The external data may be associated with a consumer record based on an email address or other personal data matched to email address 702 and/or personal data 703.

Consumer record 701 may further include aggregations and/or analysis 710. These aggregations and analyses may be calculated by data exchange system 701 based on other information associated with a consumer, as well as other available data and/or statistical and mathematical models available to the data exchange system. The aggregations and analyses may be calculated on a periodic basis and/or calculated in real time upon appropriate requests. Various examples of aggregations and analysis are provided herein, and it will be understood that additional aggregations and/or analyses may be included, and any subset of the aggregations and analyses may be included.

In an embodiment, the data exchange system calculates an activity score or address utilization rate. The activity score may indicate the consumer's interactions with messages sent to that consumer's email address. The interactions may be categorized and then used to calculate the activity store. Thus, the activity score may indicate the degree to which the consumer uses emails sent to the particular email address. Additionally, the activity score may indicate whether a consumer is emotionally active or inactive (that is, whether the consumer reads and/or interacts with emails), and/or whether the consumer is truly active or inactive (that is, whether the email address is functional and actually checked). The activity score thus allows clients to know whether their messages are being sent to actively engaged email addresses. For example, communicators may use the activity score to identify truly inactive and emotionally inactive subscribers, so that the communicators can engage in effective reengagement strategies.

In an embodiment, activity scores are calculated based on activities including conversion, social share, click, open, forward, signup, unsubscribe, responding, complete reading, and/or marking a message as spam, for example. Determining whether a message is read entirely may be performed, for example, by determining whether a pixel at the bottom of the message was viewed. In various embodiments, the activities may be weighted differently, and some of the activities may be weighted negatively in calculating the activity score. The activity score calculation may be made based on a statistical model or other model configured to predict, for example, an increased likelihood of conversion of the consumer. In an embodiment, the activity score is represented as a 3-digit number, with 000 corresponding to no activity, 001 corresponding to low activity, 100 corresponding to high activity, and 999 corresponding to unknown activity. Activity scores may be provided on any other scales, such as 1-10, 1-100, A-F, 420-820, etc.

In an embodiment, the data exchange system calculates an email address rank for a consumer's email address. The email type or rank indicates a consumer's primary, secondary or other email address according to the quantity and type of interactions at that address, in an embodiment. This information may be useful to communicators, for example, in evaluating signup sources or setting interaction expectations, as a result of those communicators understanding whether they are messaging a primary, secondary or other email address. In various embodiments, more or fewer categorizations may be included and/or categorizations of different aspects of email addresses or other information may be included. In an embodiment, the email rank may be represented as a single digit number with 0 corresponding to an unknown rank, 1 corresponding to a primary rank, 2 corresponding to a secondary rank, and 3 corresponding to another rank.

In an embodiment, the data exchange system is configured to determine whether an email address is being used by multiple users. An indication that an email address is used by multiple users may be useful in informing communicators about the reliability and/or usefulness of a particular email address. In an embodiment, the multiple users indicator may take on the values of unknown, yes or no. In an embodiment, the data exchange system differentiates records for each of the multiple consumers so that multiple consumer records may be associated with a single email address.

In an embodiment, the data exchange system is configured to determine the best time(s) of day, day(s) of week, and/or other time or data information, for sending messages to the consumer. For example, through analysis of a consumer's email activity patterns, the data exchange system may be able to determine that the consumer views emails at a certain time of the day and/or views emails more frequently on certain days of the week (e.g., a peak interaction time). This information may be useful to communicators, as emails at the top of a consumer's inbox and/or emails that arrive while a consumer is reading other messages, may receive more interest and/or activity from the consumer.

In an embodiment, a best time of day is identified by the data exchange system. The best time of day may be identified as a range of time, such as an hour. In an embodiment, the data exchange system may further calculate a degree of confidence to associate with the identified time. In an embodiment, the data exchange system may identify multiple times, possibly associated with degrees of activity for the identified times. In an embodiment, different times of day may be identified for different days of the week, days of the month, weeks of the month, weeks of the year, months of the year, or the like.

In an embodiment, the data exchange system determines a best day (or best days) of the week for sending messages to the consumer. As with the best hour, the best day of the week may be associated with a degree of confidence, in various embodiments. Additionally, in an embodiment, multiple days of the week may be identified, possibly in combination with degrees of interest for the identified days of the week. In various embodiments, other data information may be identified, such as the consumer's email activity on holidays or at various times during fiscal quarters or years.

The data exchange system may calculate the best time (or best times) and day (or days) information based on certain activity data associated with the consumer. In an embodiment, the activities relating to opens and clicks are used in calculating the best time and day information. In an embodiment, consumers may be aggregated by segments in determining best time and day information to reduce statistical uncertainty where there is insufficient time and day information about a single consumer. Thus, for example, in some embodiments, the data exchange system may determine a best time of day based on opens, a best time of day based on clicks, a best time of day based on conversion, and so on.

In an embodiment, the data exchange system is configured to determine a device preference of a consumer. The device preference may identify a particular device preferred by the consumer for reading email messages. In an embodiment, the device identified may be a PC, tablet, mobile phone, unknown device, or other such device. The device preference may be determined using device information 512 of FIG. 5. In an embodiment, the data exchange system combines time and day information with device information to determine a consumer's device preference at different times of the day. Thus, for example, the data exchange system may determine that a consumer uses mobile devices to read emails during working hours, but uses a PC or tablet device during nonworking hours. Such information may be used by communicators in designing messages tailored to the device that the consumer is likely to view the message on.

In an embodiment, the data exchange system is configured to determine an operating system (“OS”) preference of a consumer, which may be determined separately or in combination with the device preference. For example, a device preference indicating an Android-based tablet or smartphone may determine an OS preference of “Android,” while a device preference indicating a PC may determine an OS preference of “Windows” or “Mac OS,” and so on.

In an embodiment, the data exchange system is configured to determine a last open date for a consumer. The last open date may be a time stamp indicating the last month and year an email message sent to an email address of the consumer was identified as being opened.

In an embodiment, the data exchange system is configured to determine a last click date for a consumer. The last click date may be a time stamp indicating the last month and year an email message sent to an email address of the consumer was identified as having a link within the email clicked.

In some embodiments, the data exchange system is configured to model and/or determine additional information for a consumer. For example, consumer data may be modeled based on a share of wallet model to determine, suggest, or predict a percent of discretionary spend for the consumer. The share of wallet model may leverage data received from communicators about the consumer as well as other consumer data resources. In another example, consumer data may be modeled based on a spend by category model to determine, suggest, or predict a range of consumer spend by category per email address. In another example, consumer data may be modeled based on a social influencer model to determine, generate, or otherwise create a categorical social influencer score, for example based on contributed social share data for a consumer. In another example, consumer data may be modeled based on an email verification model or process which may validate new email addresses collected at a point of sale against a cooperative database. In another example, consumer data may be modeled based on a conversion by channel model to generate or determine an indicator or a likelihood of conversion from email based, for example, on channel conversions collected by the data exchange system and associated with an email address. In another example consumer data may be modeled based on device type use percentage, for example, to indicate a percent or usage for particular devices (e.g., PC, tablet, mobile, unknown/other, etc.). In another example, an email marketing receptiveness score may be modeled for a consumer, based on and/or indicative of, for example, how often an email address is “opted-in” for consumer communications. In another example, a recency frequency monetary (“RFM”) model may be used to model a propensity of the consumer indicative of a likelihood that the consumer may make discretionary spend purchases, either in general or for a specific category. In another example, a geographic location and other attributes aggregated at a geographic level (e.g., based on a zip code or zip code+4 model) may be determined for a consumer based on a referential look-up of a referred IP address. In another example, predictive engagement may be modeled for a consumer based on, for example, brand-specific open, click, and transaction rate models in order to predict future open, click, and transaction rates for distinct periods of time (e.g., daily, weekly, monthly, etc.). In another example, a like-customer model may be utilized to segment customers into “like” or similar segments based on insights data generated by the data exchange system. In another example, a timeliness model may be utilized to determine, predict, or suggest a particular time that a consumer is “in the market” to buy a product—for example, a one-time purchase of a product at one time of year may be construed as a particular time of year the consumer is “in the market” to buy the product (rather than as perpetual interest).

The data exchange system may further determine other data through analysis and/or aggregations of information available to the data exchange system. For example, the data exchange system may determine common network and/or physical locations of the consumer based on location information 511 of FIG. 5, possibly in conjunction with geolocation information. The data exchange system may further derive metrics relating to a consumer's activity with respect to particular categories of messages relative to the consumer's overall activity. The categories may be based on category information associated with communicators. Location and category information may be used by consumers to more closely target messages to the particular interests of consumers. For example, communicators may use location information to send messages to consumers with content relating to local events.

The above-described insights, as well as other analyses and aggregations, may be used by communicators in a variety of ways. For example, communicators may use the insights to generate messages saying “Hi, nice to meet you” or “Welcome back, I've selected some products that might interest you” as appropriate to particular consumers, and otherwise customize messages to consumers. Communicators may also be able to connect online and offline interactions to create a more optimized customer experience. Communicators may further be able to segment messages by life stage, lifestyle, and other demographic and psychographic attributes to make those messages even more relevant to consumers.

Communicators may also use the data exchange system to generate reports of the effectiveness of marketing campaigns and other communications with consumers. These reports may be made at a brand level, product level, geographic level, national level and so on. The reports may include consumer profiles based on the insights, aggregations and analyses provided by the data exchange system.

The reports may include behavioral analysis data. For example, the reports may compare the degree of engagement or interest of a particular consumer's subscribers with industry averages or other metrics. The reports may also compare the quantities of primary, secondary, and other addresses, giving communicators a sense of the degree of interest of subscribing consumers, possibly in comparison with other communicators. The reports may also analyze device usage among consumers receiving messages from a communicator, providing trending information to indicate device preferences of consumers over a period of time. Additionally, the reports may indicate times when consumers are likely to interact with messages from a communicator, possibly in comparison with others.

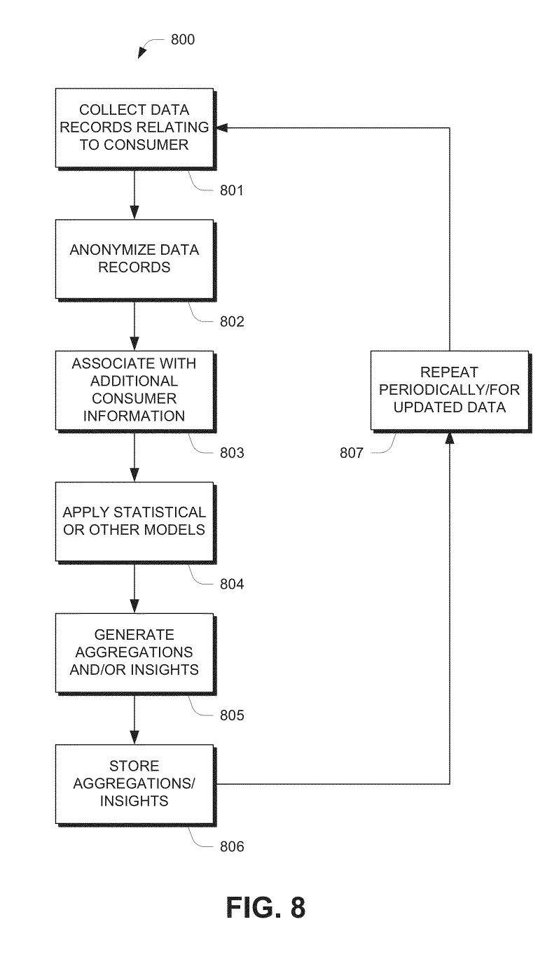

FIG. 8 is a flowchart of a process 800 of gathering and analyzing consumer data, as used in an embodiment. The process may be performed by data exchange system 101 of FIG. 1. In various embodiments, additional blocks may be included, some blocks may be removed, and/or blocks may be connected or arranged differently from what is shown.

At block 801, the data exchange system collects one or more records relating to a consumer. The records may be collected, for example, from multiple communicators.

At block 802, the data records received at block 801 may be anonymized. As described previously, records may be anonymized by hashing, encrypting, obfuscating, or other such techniques. Additionally, as described previously, email addresses may be canonicalized to ensure that the anonymized email addresses can later be matched.

At block 803, the data exchange system associates the records with additional consumer information. Such information may be drawn, for example, from consumer data 102 of FIG. 1.

At block 804, the data exchange system applies statistical, mathematical, or other models in order to generate aggregations and/or insights at block 805. Various aggregations and insights have been described throughout the specification. At block 806, the aggregations and/or insights may be stored by the data exchange system. In an alternate embodiment, the data exchange system may calculate aggregations and/or insights at the time of a request from a communicator so that they need not be stored at block 806.

At block 807, the data exchange system repeats the process on a periodic basis or at the time of receiving updated data. In an embodiment, the process is repeated on a monthly basis. The rate of updating may be based on the quantity of data maintained by the data exchange system and/or the computation speed and/or power available to the data exchange system.

In an embodiment, data received by the data exchange system at block 801 may be formatted in a manner specific to a particular communicator. In order for that data to be efficiently processed by the data exchange system, data may be mapped onto a format used by the data exchange system. Such mappings may be defined on a per-communicator basis.

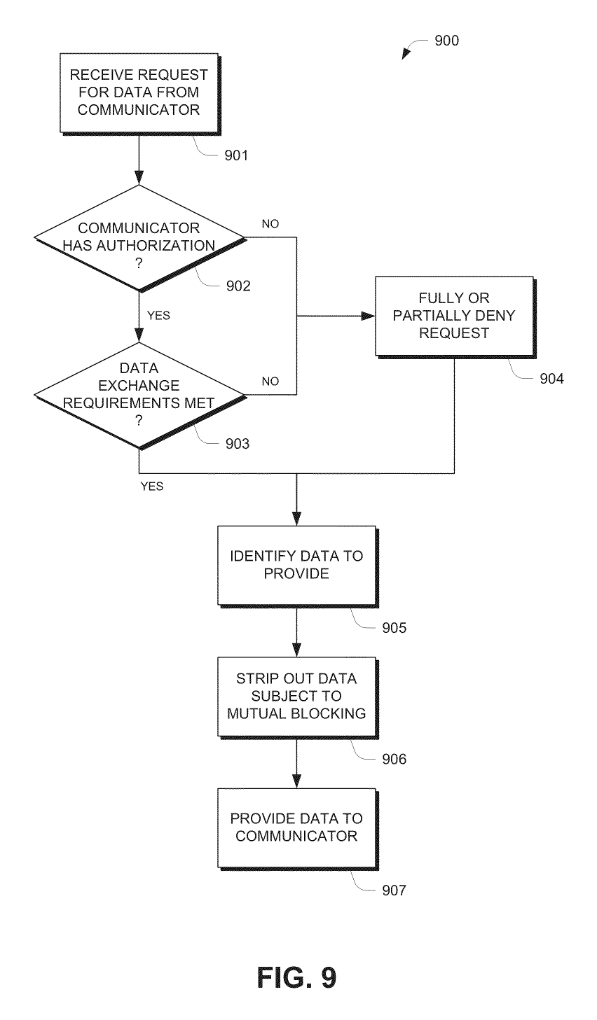

FIG. 9 is a flowchart of a process 900 of providing data to a communicator, as used in an embodiment. The process may be performed by data exchange system 101 of FIG. 1. In various embodiments, additional blocks may be included, some blocks may be removed, and/or blocks may be connected or arranged differently from what is shown.

At block 901, the data exchange system receives a request for data from a communicator. Upon receiving the request, the data exchange system performs a series of tests. For example, at block 902, the data exchange system determines whether or not the communicator has authorization to receive the requested data. Authorization may be determined based on login information, digital certificates, and/or other identifying information. Additionally, the data exchange system may determine at block 903 whether data exchange requirements, such as quota requirements and/or payment requirements, have been met by the communicator. If the tests are not satisfied, then at block 904, the data exchange system may fully or partially deny the request from the communicator, as received at block 901.

If the request satisfies the tests fully or partially, then at block 905, the data exchange system identifies the consumer data to be provided to the communicator. In an embodiment, the data to be provided is drawn from consumer records, such as consumer record 701 of FIG. 7. The data may include all or a portion of the consumer records and/or insight data. In various embodiments, the provided data includes some or all of aggregations and/or analyses 710 and/or data exchange record 708. Thus, raw data exchange records may be provided in addition to aggregations and/or analyses, in various embodiments. In some embodiments, the portion of the consumer records provided may be based on a subscription level associated with the receiving communicator. For example, a receiving communicator may be enrolled in a “basic” service which enables access to “best day” insight data, or an “intermediate” service which enables access to “best day and time” insight data, and so on in any combination of consumer data and insight data described herein. In some embodiments, a portion may also refer to providing data for only a subset of consumers, or providing data for all consumers but only a limited number of action types, and so on.

In an embodiment, a communicator may be limited to receiving information about consumers known to the requestor. Thus, a communicator may receive additional information about consumers with whom the communicator has an existing relationship, but may not receive consumer information about consumers with whom the communicator has no preexisting relationship. This may provide a measure of data privacy and security for consumers whose data is maintained by the data exchange system. In an embodiment, the data exchange system further does not provide other identifying information to communicators. For example, the data exchange system may inform a communicator that a particular email address is a secondary email address for a consumer, but not identify the consumer's primary email address to the communicator. In an embodiment, the data exchange system may inform a communicator of a primary email address associated with a secondary email address, if the communicator already is aware of the primary email address.

At block 906, the data exchange system strips out data subject to mutual blocking from the identified data of block 905. The data to be stripped may be identified in a number of ways. In an embodiment, only data specifically associated with a communicator in a mutual blocking arrangement will be blocked. Thus, aggregation data will not be stripped, even if some of the aggregation data is based on communicator data that would be subject to mutual blocking. In an embodiment, aggregation data is blocked if it includes data from a communicator subject to mutual blocking. In an embodiment, where an aggregation or analysis includes data subject to mutual blocking, then the aggregation or analysis is recalculated without the data subject to mutual blocking, and then provided to the requesting communicator. In an embodiment, aggregation or analysis data that includes data subject to mutual blocking is provided only if there is sufficient data not subject to mutual blocking such that the data subject to mutual blocking is sufficient diluted.

At block 907, the data identified from block 905 is provided to the requesting communicator. The data may be provided in a variety of formats, including text, CSV, Microsoft Excel, XML, HTML, relational database tables, and the like.

In an embodiment, the data identified at block 905 may be calculated based on a system-wide optimization or calculation. For example, it may be preferable for different communicators to send messages to a consumer at different times so that the communicator is not bombarded with multiple messages at the same time. If every communicator is sent the same value for the best time(s) of day and best day(s) of week, then there is the potential that the consumer will receive numerous emails at that time and on that day of the week. Accordingly, the data exchange system may send different values, such as different times of day or days of the week, to different communicators to avoid the problem of the consumer receiving multiple messages at the same time. The different times and days may be selected based on a randomization algorithm, weighted appropriately to the likelihood of the consumer viewing messages at that particular time or day.

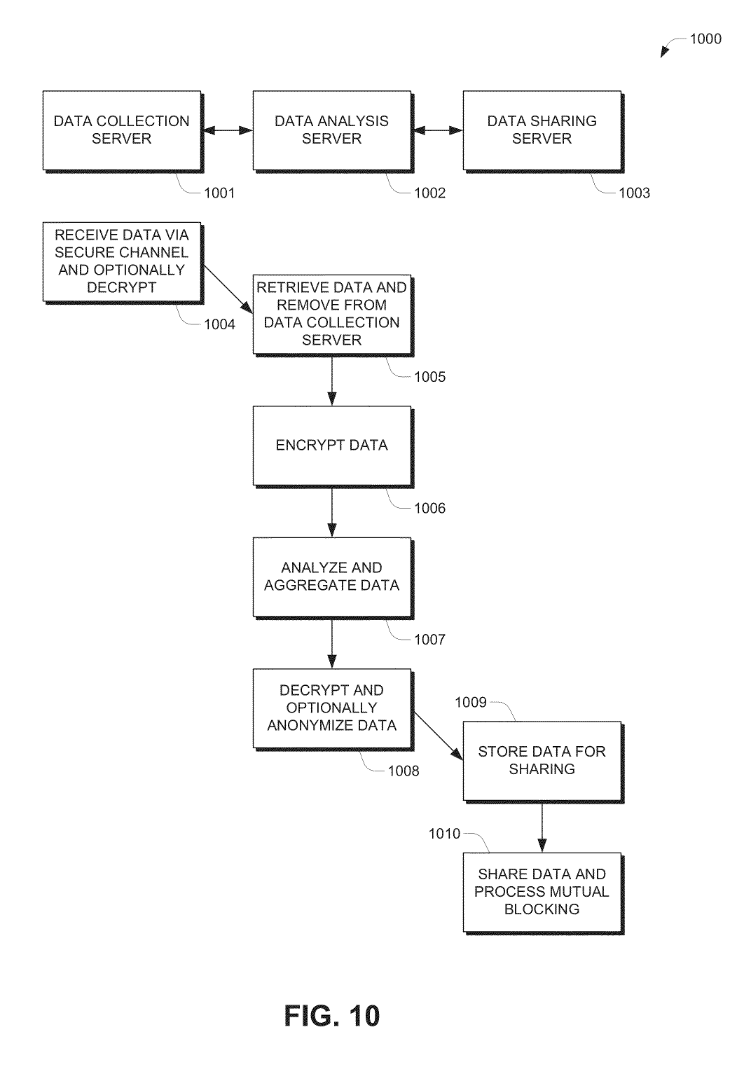

FIG. 10 is a block diagram of an implementation of a data exchange system and a flowchart of a process 1000 of managing consumer information, as used in an embodiment. In various embodiments, additional blocks may be included, some blocks may be removed, and/or blocks may be connected or arranged differently from what is shown.

In the embodiment shown in FIG. 10, three separate servers communicate with each other: data collection server 1001, data analysis server 1002, and data sharing server 1003. These servers may perform processes corresponding to the data collection module 206, data analysis and aggregation module 207, and data sharing module 208, of FIG. 2. In an embodiment, each of the servers of FIG. 10 is housed on separate computing hardware. The computing hardware may then be connected via networks and/or other communication systems. By separating the servers onto separate hardware, it may be easier to configure security settings on each of the servers to prevent data breaches and other unwanted data accesses.

The various servers of FIG. 10 may interact with each other to perform one or more processes or operations. In the embodiment shown in FIG. 10, the operations performed by each of the servers are shown directly below each of the blocks representing the servers.

At block 1004, the data collection server 1001 receives data relating to consumers. The data may include data exchange records 501, as shown in FIG. 5. In an embodiment, the data is received via a secure channel, such as SFTP or SCP. In an embodiment, the data received by the data collection server 1001 is optionally encrypted using a key associated with the sender of the data, in which case the data collection server 1001 may optionally decrypt the data at block 1004.

At block 1005, the data analysis server 1002 retrieves the data stored at block 1004 and removes that data from data collection server 1001. At block 1006, the data analysis server may encrypt the data retrieved at block 1005 using an encryption key associated with the data analysis server. By encrypting the date at block 1006, the data analysis server provides an additional guarantee against data breaches and data loss.

At block 1007, the data analysis server analyzes and aggregates the data retrieved from the data collection server. As a result of the analysis and aggregation, the data analysis server decrypts and optionally anonymizes the resulting data at block 1008.

At block 1009, the data sharing server receives the decrypted and optionally anonymized data from data analysis server 1002. The data sharing server 1003 may then store the data for sharing at a later time. In an alternate embodiment, data sharing server 1003 retrieves data from the data analysis server 1002 upon a request from a communicator, in which case the data need not be stored at data sharing server 1003.

At block 1010, the data sharing server 1003 shares data with communicators and optionally processes mutual blocking, as explained for example with respect to block 906 of FIG. 9. Alternately, mutual blocking rules may be processed beforehand by either data sharing server 1003 or data analysis server 1002, in which case mutual blocking need not be assessed at the time a request is made by a communicator.

FIGS. 11-15 illustrate example data visualizations that include information usable by a participant/communicator in communicating with consumers, such as times, dates, and content of marketing messages to specific consumers. The data associated with the “EI” labels (“Email Insight”) refers to some combined, aggregated, and/or averaged data across multiple communicators. For example, the EI data may include averages across all communicators that participate in an email exchange service. In other embodiments, the EI data may be filtered in some way, such as to include averages of data from communicators only in a particular vertical market or excluding one or more vertical markets, for example. Although the term “email insight” is used in these examples, the examples may also apply to other channels of contact or communication as described herein (e.g., phone number, mailing address, cookie, username, etc.). Thus, any reference to “email” may be replaced with other communication channels in various other embodiments.

The various graphs, charts, and other visualizations included in these figures may be provided to communicators in various manners. For example, a communicator may access such information via a portal that is accessible via a web browser. Similarly, in some embodiments a communicator may have a standalone software application installed on a desktop computer or mobile device that provides the information. The communicator may also receive such data via email or in batch files, such as in data structured in a database, comma separated values, text file, and/or any other available data format.

The example data visualizations shown in FIGS. 11-15 may be calculated and generated, for example, according to Tables 1-4 described below. Table 1 lists several input “base count” variables which may be provided to or determined by the data exchange system. The input variables in Table 1 may then be used to perform various calculations as described with reference to the examples described in FIGS. 11-15 and in Tables 2-4.

TABLE 1
Base Count Variables

| Count/ | | |
|---|---|---|
| Calculation | Description | Explanation |
| A | Number of Active Unique | Based on Earliest Action Date within |
| | Emails Addresses | current 13 months per unique email an |
| | | email is flagged active (1) for the earliest |
| | | date to current. Those with at least 1 of |
| | | the following actions on record: Open; |
| | | Click; Transaction; or Unsubscribe are |
| | | considered active. Sum number of |
| | | unique email ids active flag per month. |
| Y | Number of Unique | Aggregate unique email addresses |
| | Emails Addresses | across 13 month reporting period |
| C | Number of Opens | Sum the number of opens across all |
| | | email addresses |
| D | Number of Clicks | Sum the number of clicks across all |
| | | email addresses |
| E | Number of Transactions | Sum the number of transactions across |
| | (Conversions) | all email addresses |
| F | Number Unsubscribes | Sum the number of unsubscribes across |
| | | all email addresses |
| G | Number of Opens, | Sum (Count C, D, E, F) |
| | Clicks, Transactions, | |
| | Unsubscribes | |

FIG. 11 shows a data table 1100A and corresponding graphs 11008 and 1100C illustrating an example of “email action” insight data which may be generated by a data exchange system according to the processes described herein, as used in an embodiment. Although FIG. 11 illustrates a particular example with reference to insight data for email, in other embodiments any other insight data related to any type of contact data (e.g., phone numbers, mailing addresses, etc.) as described herein may be similarly generated and provided. The particular example shown in FIG. 11 illustrates insight data about email actions (e.g., opens, clicks, transactions, and unsubscribes) taken by consumers, collected by communicators, and provided to the data exchange system for aggregation and analysis. The data table 1100A and corresponding graphs 11008 and 1100C illustrate the potential benefit of the data exchange system in that a comparison of email actions over time can reveal consumer email engagement levels. Understanding historic trends may help communicators set engagement expectations for future time periods.

The data table 1100A illustrates email actions as ratios of the average number of actions per email address. In this particular example, all of the actions taken at a particular email address are included in the ratio calculations, and not just one unique action per email address. For example, all “open” actions for a particular email address are included in the sum of all “open” actions across all email addresses. Thus, if one “open” action is counted for a first email address and three “open” actions are counted for a second email address, the sum of all “open” actions across this set of two email addresses is four. Thus, in this example, the ratio of the average number of “open” actions per email address would be calculated as two. As shown in data table 1100A, email actions may be further sub-divided and/or compared to other email actions (e.g., clicks/opens, transactions/opens, transactions/clicks) to provide even more detailed analysis of consumer email action behavior. The data table 1100A shows email action data for a particular participant as compared to an aggregate total (the Email Insight or “EI” column(s)), both for the current month and over the last twelve months (although other time periods may be used just as well). In some embodiments the aggregate total in the EI column may include aggregate data across all participants in the data exchange system, while in other embodiments, the aggregate total in the EI column may include aggregate data across a subset or participants in the data exchange system (e.g., a subset of participants with a shared or common attribute with the particular participant, such as a similar type or line of business). The graphs 11008 and 1100C illustrate two example metrics from data table 1100A (e.g., clicks/opens in graph 11008 and transactions/clicks in graph 1100C) in a line graph format comparing the participant to the aggregate total. This provides the communicator with a greater degree of insight into the participant's email action behavior both independently and/or in relation to an overall total.

Table 2 shown below provides one example of how email action calculations may be performed and used to generate the exemplary insight data described and illustrated with reference to FIG. 11. References to counts in the Explanation column (“Count A,” “Count C,” etc.) refer to Count/Calculation variables listed in Table 1 above.

TABLE 2
Email Action Calculations

| Count/ | | |
|---|---|---|
| Calculation | Description | Explanation |
| 1 | Average opens per | Count C/Count A |
| | address | |
| 2 | Average clicks per | Count D/Count A |
| | address | |
| 3 | Average transactions per | Count E/Count A |
| | address | |
| 4 | Average unsubscribes | Count F/Count A |
| | per address | |
| 5 | Total Actions Per Email | Count G/Count A |
| 6 | 12 month average of | Sum Month 1 thru Month 12 Count |
| | “Average opens per | C/Sum Month 1 thru Month 12 Count A |
| | address” | |
| 7 | 12 month average of | Sum Month 1 thru Month 12 Count D/ |
| | “Average clicks per | Sum Month 1 thru Month 12 Count A |
| | address” | |
| 8 | 12 month average of | Sum Month 1 thru Month 12 Count E/ |
| | “Average transactions | Sum Month 1 thru Month 12 Count A |
| | per address” | |
| 9 | 12 month average of | Sum Month 1 thru Month 12 Count F/ |
| | “Average unsubscribes | Sum Month 1 thru Month 12 Count A |
| | per address” | |
| 10 | 12 month average of | Sum Month 1 thru Month 12 Count G/ |
| | “Average total actions | Sum Month 1 thru Month 12 Count A |
| | per address” | |
| 17 | Clicks to Opens % | Count D/Count C |
| 18 | Transactions to Opens % | Count E/Count C |
| 19 | Transactions to Clicks % | Count E/Count D |
| 20 | Clicks to Open % - 12 | Sum Current Month thru Month 12 Count |
| | Month Avg. | D/Sum Current Month thru Month 12 |
| | | Count C |
| 21 | Transactions to Open % - | Sum Current Month thru Month 12 Count |
| | 12 Month Avg. | E/Sum Current Month thru Month 12 |
| | | Count C |
| 22 | Transactions to Clicks | Sum Current Month thru Month 12 Count |
| | % - 12 Month Avg. | E/Sum Current Month thru Month 12 |
| | | Count D |

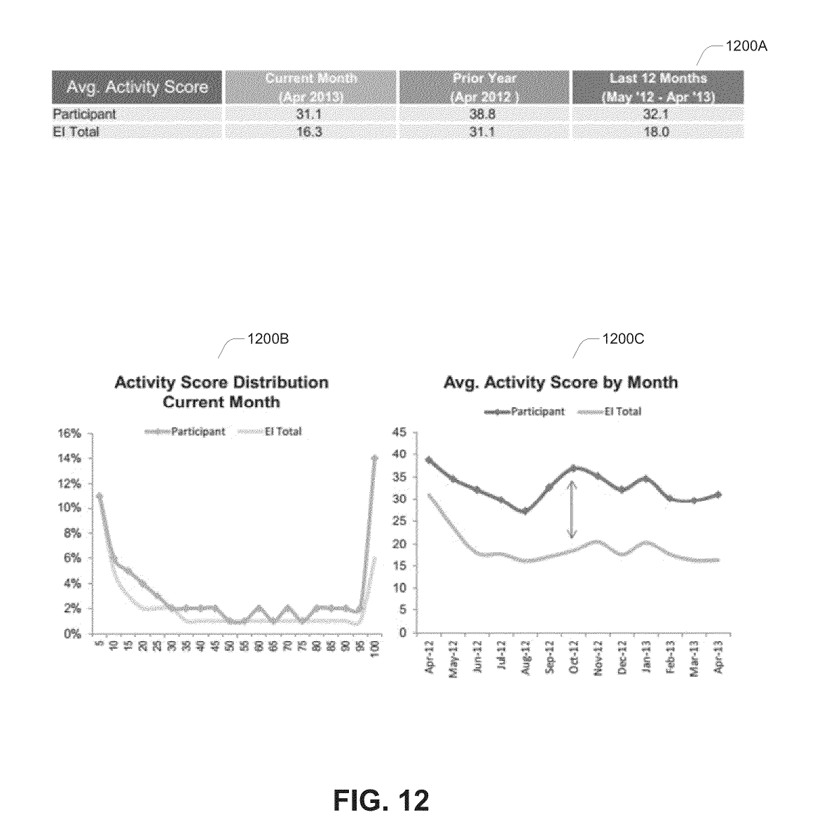

FIG. 12 shows a data table 1200A and corresponding graphs 1200B and 1200C illustrating an example of “email activity score” insight data which may be generated by a data exchange system according to the processes described herein, as used in an embodiment. Although FIG. 12 illustrates a particular example with reference to insight data for email, in other embodiments any other insight data related to any type of contact data (e.g., phone numbers, mailing addresses, etc.) as described herein may be similarly generated and provided. The particular example shown in FIG. 12 illustrates insight data about email activity scores based on email actions taken by consumers, collected by communicators, and provided to the data exchange system for aggregation and analysis. The data table 1200A and corresponding graphs 1200B and 1200C illustrate the potential benefit of the data exchange system in that the email activity scores may provide a relative comparison of email responsiveness across email addresses and over time. In the example shown in FIG. 12, the activity score of “100” represents the highest rate. An average activity rate may be provided to illustrate responsiveness over a given time period, while a distribution may show the overall composition of activity scores contributing to the average.

The data table 1200A illustrates email activity scores for a particular participant and for an aggregate total (the “EI” row), for the current month, over the prior year, and over the last twelve months (although other time periods may be used just as well). The graphs 1200B and 1200C illustrate two example metrics from data table 1200A (e.g., activity score distribution for the current month in graph 1200B and average activity score by month over time in graph 1200C) in a line graph format, comparing the participant to the aggregate total. This provides the marketer with a greater degree of insight into the participant's email activity score both independently and/or in relation to an overall total.

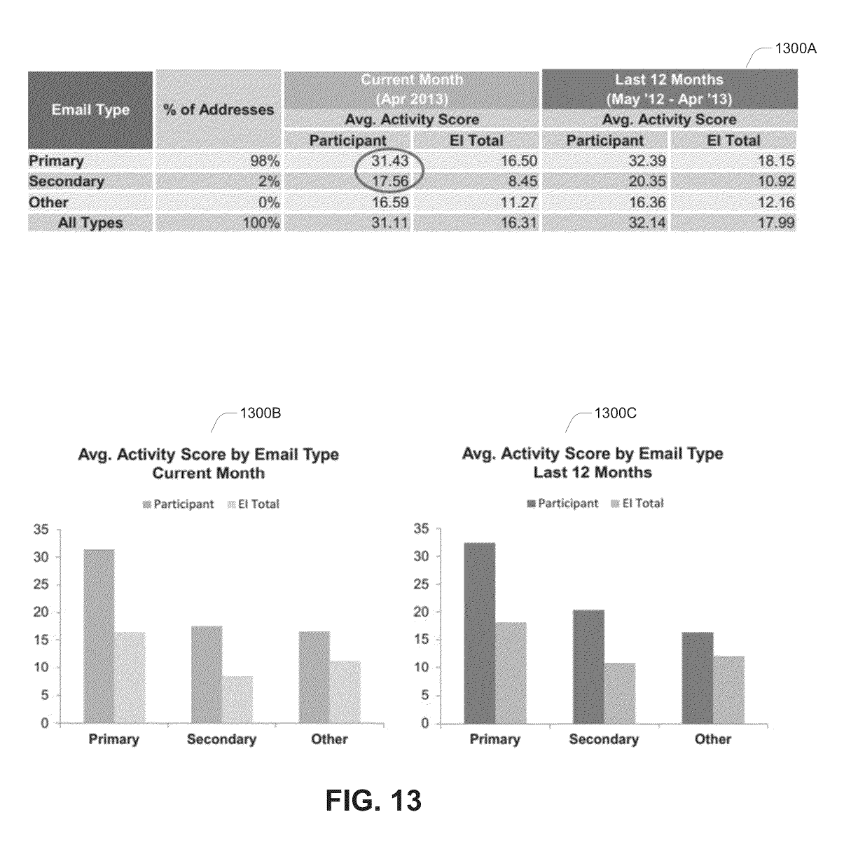

FIG. 13 shows a data table 1300A and corresponding graphs 1300B and 1300C illustrating an example of “email type” insight data which may be generated by a data exchange system according to the processes described herein, as used in an embodiment. Although FIG. 13 illustrates a particular example with reference to insight data for email, in other embodiments any other insight data related to any type of contact data (e.g., phone numbers, mailing addresses, etc.) as described herein may be similarly generated and provided. The particular example shown in FIG. 13 illustrates insight data about email types based on types of email addresses used by consumers, collected by communicators, and provided to the data exchange system for aggregation and analysis. The data table 1300A and corresponding graphs 1300B and 1300C illustrate the potential benefit of the data exchange system in that the email type data may provide a view of consumer email activity across multiple email addresses. In the example shown in FIG. 13, the email type is determined by matching email addresses to consumers. When more than one email address is matched to a consumer, the email addresses may be ranked based on reported activity (e.g., primary, secondary, other). If only one email address is matched to a consumer, that email addresses may simply be the “primary.”

The data table 1300A illustrates email type insight data for a particular participant and for an aggregate total (the “EI” column), for the current month and over the last twelve months (although other time periods may be used just as well). The graphs 1300B and 1300C illustrate two example metrics from data table 1300A (e.g., average activity score by email type for the current month in graph 1300B and average activity score by email type over the past twelve months in graph 1300C) in a line graph format, comparing the participant to the aggregate total. This provides the marketer with a greater degree of insight into the participant's email type data both independently and/or in relation to an overall total. Email type insight data may be useful to marketers because although a smaller percentage of consumers have multiple email addresses, those consumers with multiple email addresses tend to be more responsive in general. Thus, activity expectations may be adjusted once the email type is known.

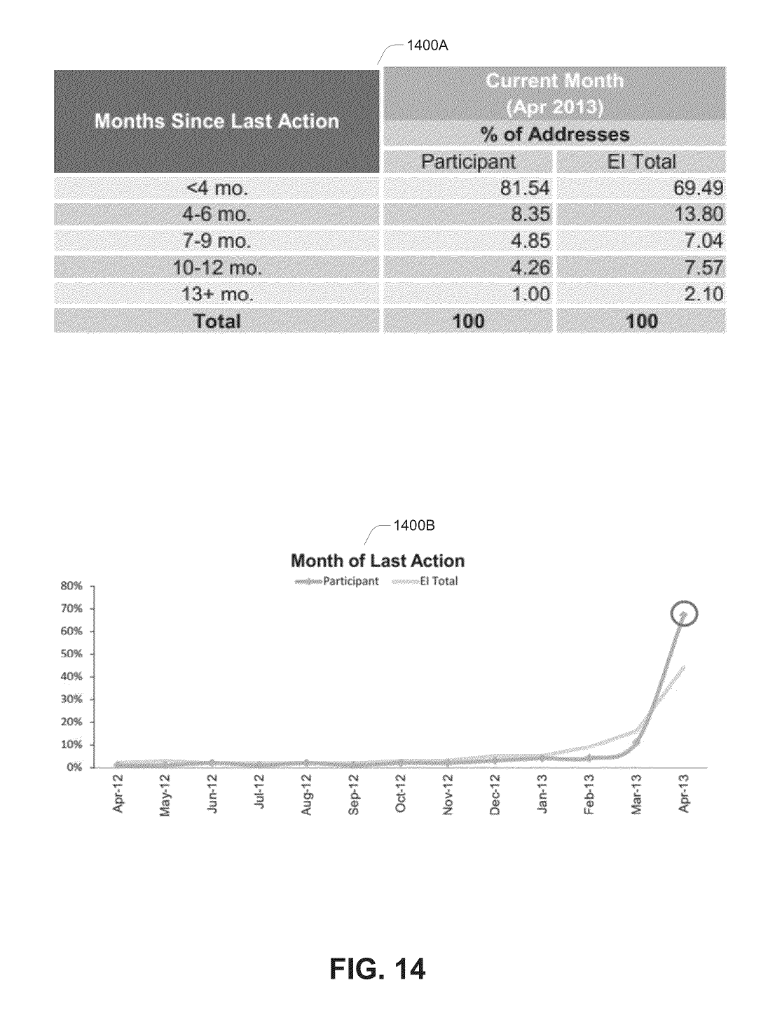

FIG. 14 shows a data table 1400A and corresponding graph 1400B illustrating an example of “recency of engagement” insight data which may be generated by a data exchange system according to the processes described herein, as used in an embodiment. Although FIG. 14 illustrates a particular example with reference to insight data for email, in other embodiments any other insight data related to any type of contact data (e.g., phone numbers, mailing addresses, etc.) as described herein may be similarly generated and provided. The particular example shown in FIG. 14 illustrates insight data about the recency of engagement by consumers based on the time elapsed since the last recorded action for each email address used by consumers, collected by communicators, and provided to the data exchange system for aggregation and analysis. The data table 1400A and corresponding graph 1400B illustrate the potential benefit of the data exchange system in that the recency of engagement data allows a participant to confirm email addresses that are active, even if the consumers are not opening messages from that participant. In some cases, the reputation of the sender may be negatively influenced by sending messages to inactive accounts.

The data table 1400A illustrates recency of engagement (e.g., number of months since last action) insight data for a particular participant and for an aggregate total (the “EI” column) for the current month (although other time periods may be used just as well). The graph 1400B illustrates the month of last action data from data table 1400A in a line graph format, comparing the participant to the aggregate total. This provides the marketer with a greater degree of insight into the participant's recency of email engagement both independently and/or in relation to an overall total.

Table 3 shown below provides one example of how recency of engagement calculations may be performed and used to generate the exemplary insight data described and illustrated with reference to FIG. 14. References to counts in the Explanation column (“Count A,” “Count C,” “1,” etc.) refer to Count/Calculation variables listed in Tables 1 and 2 above.

TABLE 3
Recency of Engagement Calculations

| Count/ | | |
|---|---|---|
| Calculation | Description | Explanation |
| 71 | Recency of last action | Calculate number of months since |
| | | newest action date created on GI file |
| | | using the end of the current month and |
| | | time as reference point. Depending |
| | | upon the date function used a 1 could be |
| | | added so that emails within the current |
| | | month are not zeros. |
| 72 | Percentage of emails by | Using recency of last action (71), and |
| | Recency of Last Action | predefined month ranges, sum the |
| | | number of email addresses by range and |
| | | divide each sum by the total number of |
| | | emails (Count A Current month) * 100. |
| | | (Month ranges may be as follows: 1-3, 4-6, |
| | | 7-9, 10-12, 13+, etc.) |
| 73 | Percentage of emails by | Using recency of last action (71), and |
| | Month of Last Action | predefined month ranges, sum the |
| | | number of email addresses by range and |
| | | divide each sum by the total number of |
| | | emails (Count A Current Month) * 100. |
| | | (Predefined Month Ranges may include |
| | | monthly = 1, 2, 3, 4, 5, 6, 7, 8, 9, 10, 11, 12, 13) |
| | | (Month 1 represents Current Month) |

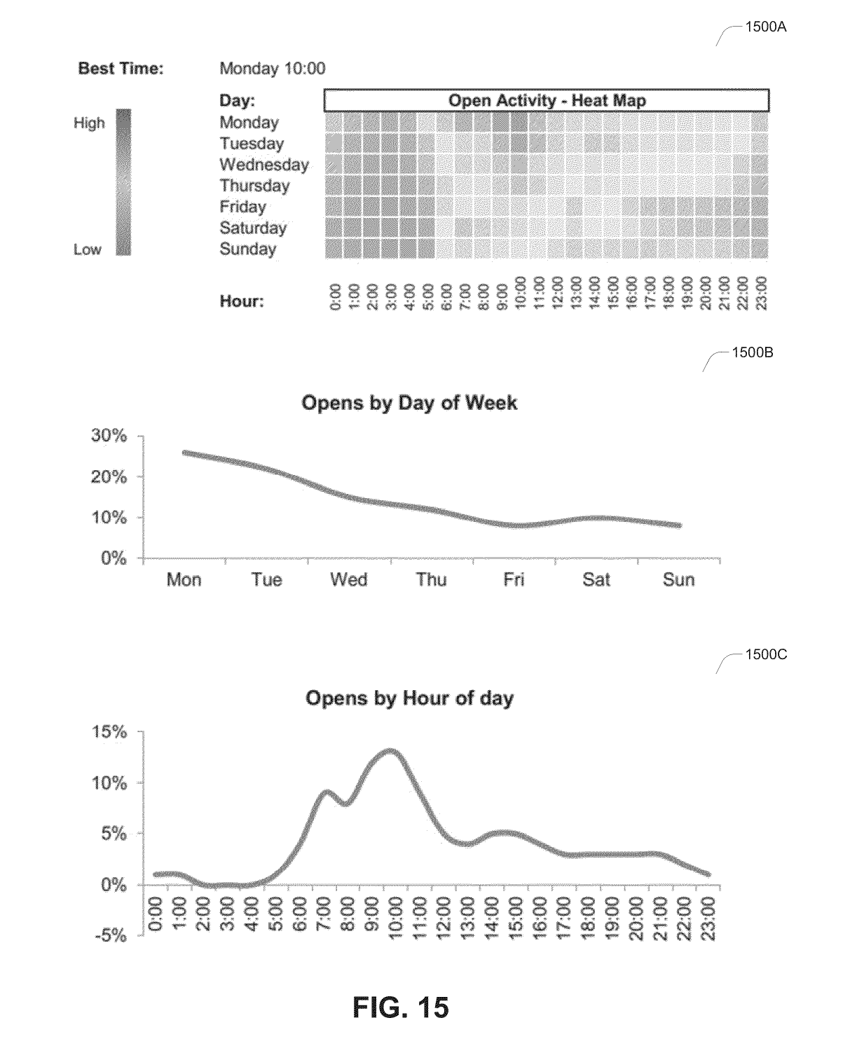

FIG. 15 shows a data table 1500A and corresponding graphs 1500B and 1500C illustrating an example of “best time to email” insight data which may be generated by a data exchange system according to the processes described herein, as used in an embodiment. Although FIG. 15 illustrates a particular example with reference to insight data for email, in other embodiments any other insight data related to any type of contact data (e.g., phone numbers, mailing addresses, etc.) as described herein may be similarly generated and provided. The particular example shown in FIG. 15 illustrates insight data about the best time to email based on all available data collected by communicators, and provided to the data exchange system for aggregation and analysis. The data table 1500A and corresponding graphs 1500B and 1500C illustrate the potential benefit of the data exchange system in that the best time to email data may help participants to improve consumer interaction with messages by sending them to the consumer's inbox during the consumer's time of email engagement. In the example shown in FIG. 15, a recommended best time is calculated for each email address that has an adequate number of recorded actions and is available in the consumer data store 102.

The data table 1500A illustrates a heat map of the “open email” action across days of the week and hours in the day. Color indicators may be used to show “hot” or “best time” (e.g., in red or orange) and “cool” or not “best time” (e.g., in green or blue). The graphs 1500B and 1500C illustrate two example metrics from data table 1500A (e.g., opens by day of week in graph 1500B and opens by hour in day in graph 1500C) in a line graph format as a percentage of the open action over the respective time frame. This provides the marketer with a greater degree of insight into the best day(s) and/or time(s) to reach consumers.

Table 4 shown below provides one example of how best time to email calculations may be performed and used to generate the exemplary insight data described and illustrated with reference to FIG. 15.

TABLE 4
Best Time to Email Calculations

| Count/ | | |
|---|---|---|
| Calculation | Description | Explanation |
| 131 | Count of | By Best day and hour, sum the number |
| | records with | of unique emails with opens. The best |
| | opens by best | day and time with the highest count of |
| | time of day | unique email ids is the best time to email |
| | and hour | recommendation. Records without action |
| | | opens will have a missing value best day |
| | | and time. |
| 132 | Percentage of | For each best day of week, sum the |
| | opens by day | number of unique emails with opens then |
| | of week | divide by the number of emails with best |
| | | time. |
| 133 | Percentage of | For each best hour of a day, sum the |
| | opens by hour | number of number of unique emails with |
| | of day | opens then divide by number of |
| | | emails (12 months) with best hour |

In one embodiment, a communicator may initiate a marketing campaign to a database of consumers and allow the data exchange system to automatically transmit messages to individual consumers based on various email insight data discussed above. For example, the communicator may initiate the marketing campaign on a Monday morning and the data exchange system may transmit messages to respective consumers in the communicator database at various dates and times over the next week (or longer period) based on the determined best time and best date information for respective consumers. Thus, in some embodiments the communicator may not be interested in viewing the visualizations of data, but instead may instruct the data exchange system to automatically determine such data and use the data in automatically executing the communicators marketing campaign.

### Other

For ease of explanation, the examples and illustrations described herein are described primarily with reference to email as a communication channel and/or email insight data generated by the data exchange system. However, in general, these examples and illustrations may also apply to any type of communication channel and/or insight data described in this disclosure. That is, the processes performed by various embodiments of data exchange systems as described herein may relate to generating insight data for any type of contact data and/or communication channel (e.g., phone numbers, mailing addresses, etc.), separately and/or in combination with email.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and tasks described herein may be performed and fully automated by a computer system. The computer system may, in some cases, include multiple distinct computers or computing devices (for example, physical servers, workstations, storage arrays, and so forth) that electronically communicate and interoperate over a network to perform the described functions. Each such computing device typically includes a processor (or multiple processors) that executes program instructions or modules stored in a memory or other computer-readable storage medium. Where the system includes multiple computing devices, these devices may, but need not, be co-located. The results of the disclosed methods and tasks may be persistently stored by transforming physical storage devices, such as solid state memory chips and/or magnetic disks, into a different state.

All of the methods and processes described above may be embodied in, and fully automated via, software code modules executed by one or more general purpose computers. The code modules may be stored in any type of computer-readable medium or other computer storage device. Some or all of the methods may alternatively be embodied in specialized computer hardware. The results of the disclosed methods be stored in any type of computer data repository, such as relational databases and flat file systems that use magnetic disk storage and/or solid state RAM.

Many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A computer system for providing consumer insight data, the computer system comprising:
a computing device comprising one or more computer processors in communication with a physical data store storing consumer data, wherein the computing device is configured to:
receive, from at least two entities that do not share contact information, consumer data exchange records each associated with a consumer, the consumer data exchange records each including identification information of the consumer and at least one email address of the consumer;
access, from the consumer data exchange records and/or from one or more entities that track email activity of consumers, activity data of the consumer associated with each of the at least two entities, the activity data including at least information regarding frequencies that the consumer opens and/or clicks on received emails from the respective entities;
storing in the physical data store an aggregated consumer data exchange record comprising an aggregate of the received consumer data exchange records from the at least two entities and the activity data associated with the at least two entities;
analyze the aggregated consumer data exchange record to generate insight data about behavior of the consumer, the insight data including at least aggregated activity data based on respective activity data associated with the at least two entities, and a best day of the week and/or time of day to contact the consumer determined based at least on the aggregated activity data; and
provide at least a portion of the insight data to one or more of the at least two entities.

2. A computer system for providing consumer insight data, the computer system comprising:
a computing device comprising one or more computer processors in communication with a physical data store storing consumer data, wherein the computing device is configured to:
receive, from one or more communicators, two or more consumer data exchange records associated with a consumer;
aggregate the received consumer data exchange records into an aggregated consumer data exchange record for the consumer, wherein the aggregated consumer data exchange record is stored in the physical data store;
analyze the aggregated consumer data exchange record to generate insight data about behavior of the consumer;
receive, from a particular communicator, a request for insight data for the consumer;
determine a level of authorization for the particular communicator; and
provide an authorized portion of the insight data for the consumer to the particular communicator based at least in part on the level of authorization.

3. The computer system of claim 2, wherein each of the two or more consumer data exchange records comprises at least a set of consumer data or a set of activity data.

4. The computer system of claim 3, wherein the set of consumer data comprises one or more of an email address, a telephone number, a name, an address, or personal information for the consumer.

5. The computer system of claim 3, wherein the set of activity data comprises one or more of an action type for an activity, a date and time of the activity, a location of the activity, a device used for the activity, or one or more action parameters associated with the activity.

6. The computer system of claim 5, wherein the action type for an activity is selected from a list comprising sign up for mailing list, open an email, click on links within an email, engage in a transaction based on email, unsubscribe from mailing list, share message on a social network, and forward message.

7. The computer system of claim 2, wherein the insight data about behavior of the consumer comprises one or more of a consumer segment for the consumer, a location of the consumer, a best time to reach the consumer, a best day to reach the consumer, a device preference of the consumer, or a consumer engagement indicator.

8. The computer system of claim 2, wherein the computing device is further configured to anonymize the received consumer data exchange records.

9. The computer system of claim 2, wherein the computing device is further configured to:
receive, on a periodic basis from the one or more communicators, updated consumer data exchange records;
update the aggregated consumer data exchange record based on the updated consumer data exchange records; and
generate updated insight data about behavior of the consumer based on the updated consumer data exchange record.

10. The computer system of claim 2, wherein the two or more consumer data exchange records are received in an encrypted data format over a secure network channel.

11. The computer system of claim 2,
wherein to determine a level of authorization for the particular communicator, the computing device is further configured to:
determine whether the particular communicator is authorized to receive insight data for the consumer based on a set of credentials provided by the particular communicator;
in response to determining that the particular communicator is authorized:
access, from the physical data store, one or more data exchange requirements associated with the particular communicator; and
determine whether at least some of the one or more data exchange requirements have been satisfied; and
wherein to provide the authorized portion of the insight data for the consumer to the particular communicator based at least in part on the level of authorization, the computing device is further configured to:
in response to determining that the particular communicator is not authorized, determine the authorized portion of the insight data as none of the insight data; or
in response to determining that at least some of the one or more data exchange requirements have been satisfied:
determine the authorized portion of the insight data as at least some of the insight data; and
provide the at least some of the insight data to the particular communicator.

12. The computer system of claim 2, wherein to provide the authorized portion of the insight data for the consumer to the particular communicator based at least in part on the level of authorization, the computing device is further configured to:
access a mutual blocking rule associated with the particular communicator, the mutual blocking rule configured to block some of the insight data for the consumer from sharing with the particular communicator;
generate the authorized portion of the insight data for the consumer by removing at least some of the insight data for the consumer based on the mutual blocking rule; and
provide the authorized portion of the insight data for the consumer to the particular communicator.

13. A computer-implemented method for providing consumer contact insight data, the computer-implemented method comprising:
receiving, from a communicator computing system, a consumer exchange record associated with a consumer, the consumer exchange record comprising at least some contact data for the consumer;
accessing, from a physical data store that stores aggregate consumer contact data for a plurality of consumers, a consumer data record associated with the consumer;
aggregating the received consumer exchange record with the consumer data record associated with the consumer; and
generating contact insight data related to the consumer, the contact insight data modeled based on the consumer data record and the at least some contact data for the consumer.

14. The computer-implemented method of claim 13 further comprising:
receiving, from a requesting entity, a request for contact insight data for the consumer; and
providing at least a portion of the contact insight data for the consumer to the requesting entity based at least in part on a determined level of authorization of the requesting entity.

15. The computer-implemented method of claim 13 further comprising:
receiving, on a periodic basis from the requesting entity, updated consumer data exchange records associated with the consumer;
updating the consumer data exchange record associated with the consumer based on the updated consumer data exchange records; and
generating updated contact insight data related to the consumer based on the updated consumer data exchange record.

16. The computer-implemented method of claim 13 wherein the contact data for the consumer comprises one or more of an email address, a telephone number, a name, or a mailing address.

17. The computer-implemented method of claim 13 wherein the contact insight data for the consumer comprises one or more of a consumer segment for the consumer, a location of the consumer, a best time to reach the consumer, a best day to reach the consumer, a device preference of the consumer, or a consumer engagement indicator.

18. A non-transitory storage medium having stored thereon a data exchange component, said data exchange component including executable code that directs a computing device to perform a process that comprises:
collecting, on a periodic basis from a plurality of marketers, one or more data exchange records for a consumer, the one or more data exchange records including at least some contact information for the consumer;
anonymizing the one or more data exchange records;
associating the anonymized data exchange records with additional consumer information, the additional consumer information accessed from a physical data store which stores consumer data;
applying one or more statistical models to the anonymized data exchange records to generate contact insight data for the consumer; and
storing the contact insight data in the physical data store.

19. The non-transitory storage medium of claim 18 wherein the contact data for the consumer comprises one or more of an email address, a telephone number, a name, or a mailing address.

20. The non-transitory storage medium of claim 18 wherein the contact insight data for the consumer comprises one or more of a consumer segment for the consumer, a location of the consumer, a best time to reach the consumer, a best day to reach the consumer, a device preference of the consumer, or a consumer engagement indicator.
